(19) United States
(12) Patent Application Publication
(10) Pub. No.: US 2015/0175872 A1
(43) Pub. Date: Jun. 25, 2015

(54) Process For Dissolving Deposits Comprising Alkaline Earth Metal Sulfates

(71) Applicants: BASF SE, Ludwigshafen (DE); Wintershall Holding GmbH, Kassel (DE)

(72) Inventors: Walter Bertkau, Ludwigshafen (DE); Stephan Hatscher, Leidschendam (NL); Stefan Frenzel, Eislingen (DE); Uwe Ossmer, Neustadt (DE)

(73) Assignees: BASF SE, Ludwigshafen (DE); WINTERSHALL HOLDING GMBH, Kassel (DE)

(21) Appl. No.: 14/390,438

(22) PCT Filed: Mar. 27, 2013
(86) PCT No.: PCT/EP2013/056616

§ 371 Date: Oct. 3, 2014

Related U.S. Application Data
(60) Provisional application No. 61/619,445, filed on Apr. 3, 2012.

(30) Foreign Application Priority Data
Apr. 3, 2012 (EP) 12162980.2

(51) Int. Cl. C09K 8/528; E21B 37/06

(52) U.S. Cl. CPC C09K 8/528; E21B 37/06

(57) ABSTRACT

A process for dissolving deposits comprising alkaline earth metal sulfates in underground installations or installation parts for production of mineral oil, natural gas and/or water, by treating the deposits with an aqueous formulation comprising methanesulfonic acid.

### CROSS-REFERENCE TO RELATED APPLICATIONS

This Application is the National Stage Entry of PCT/EP2013/056616, filed on Mar. 27, 2013, which claims priority to European Application No. 12162980.2, filed on Apr. 3, 2012, and U.S. Provisional Application No. 61/619,445 filed on Apr. 3, 2012, which are incorporated herein by reference in their entireties.

### TECHNICAL FIELD

The principles and embodiments of the present invention relate to a process for dissolving deposits comprising alkaline earth metal sulfates in underground installations or installation parts for production of mineral oil, natural gas and/or water, by treating the deposits with an aqueous formulation comprising methanesulfonic acid.

### BACKGROUND

In the course of mineral oil and/or natural gas production, solid deposits of inorganic or organic substances can form in the mineral oil formation itself, in underground installation parts, for example the well lined with metal tubes, and in above-ground installation parts, for example separators. The formation of such deposits is extremely undesirable because they can at least hinder the production of mineral oil and, in the extreme case, lead to complete blockage of the installation parts affected.

In the course of mineral oil or natural gas production, typically not only mineral oil and/or natural gas is produced, but also water with a greater or lesser salt content. This may be water present in the formation or condensed water, or else water which has been injected into the underground formation via an injection well to maintain the pressure. Salt-containing water can also be produced in the case of geothermal power generation, in which hydrothermal water is produced, in which cold water is injected into a rock formation through an injection well and warm water is withdrawn through a production well.

Deposits of sparingly soluble inorganic salts, for example deposits of calcium carbonate or calcium sulfate, strontium sulfate or barium sulfate, can form because a higher concentration of the salts can be dissolved in the formation water under the natural conditions (high pressure, high temperature) in the rock formation than under standard conditions (1 bar, room temperature). If formation water saturated with inorganic salts gets into zones with low temperature and/or relatively low pressure on the way to the surface of the earth, sparingly soluble salts can precipitate out, for example within the formation itself, on the inner surface of the metallic lining of the production well, or else not until above-ground installation parts such as pipelines or separators. In addition, deposits may be formed by mixing of mutually incompatible waters, for example injected water and formation water, to precipitate solids.

Above-ground installation parts are comparatively easily accessible and can in principle be cleaned mechanically. Therefore, the cleaning of such installation parts generally does not present any difficulties.

Cleaning to remove impurities in underground installation parts, more particularly in the well itself or in the reservoir rock, presents greater difficulties.

While carbonatic deposits in the well or in the reservoir rock can be dissolved in a comparatively simple manner using acids, for example HCl, the removal of sulfate-proof deposits, especially of calcium sulfate, strontium sulfate and barium sulfate, presents great problems, because they are barely soluble in HCl.

For instance, there are known apparatuses which can be introduced into the well and can detect and remove deposits, for example using ultrasound techniques, as disclosed in U.S. Pat. No. 6,886,406. Such techniques, however, are comparatively costly and inconvenient.

It is additionally known that impurities in the well can be dissolved using particular formulations.

U.S. Pat. No. 2,877,848 discloses the use of the complexing agent EDTA or salts thereof for dissolution of deposits such as BaSO₄ in the well. It is optionally possible to add nonionic surfactants to the formulation.

U.S. Pat. No. 4,980,077 discloses a process for dissolving deposits composed of alkaline earth metal sulfates with polyaminocarboxylates as complexing agents in a concentration of 0.1 to 1 mol/l at a pH of 8 to 14. The complexing agent may be EDTA or DTPA. The formulation further comprises oxalate ions in a concentration of 0.1 to 1 mol/l.

U.S. Pat. No. 5,282,995 discloses a process for dissolving deposits composed of alkaline earth metal sulfates with polyaminocarboxylates such as EDTA or DTPA in an alkaline medium. The formulation further comprises formate ions.

U.S. Pat. No. 5,548,860 discloses a process for dissolving deposits composed of alkaline earth metal sulfates with polyaminocarboxylates such as EDTA or DTPA in an alkaline medium. The formulation further comprises a synergist selected from the group of oxalate, thiosulfate, salicylate or nitriloacetate anions. The removal by dissolution is supported by ultrasound.

However, the use of alkaline solutions of complexing agents such as EDTA or DTPA is associated with a number of disadvantages.

Deposit water comprising alkaline earth metal ions such as Mg²⁺, Ca²⁺, Sr²⁺ and/or Ba²⁺ and HCO₃⁻ has a low pH. If an alkaline solution of complexing agents is injected into a well, at least some of the alkaline solution mixes with the deposit water. This results in secondary precipitations, for example of Mg(OH)₂, Ca(OH)₂ or CaCO₃, which can block the formation and/or the well. In addition, the efficiency is low: the complexing agent at first complexes the alkaline earth metal ions present in the solution and does not attack the deposits at first.

Measures therefore have to be taken to prevent deposit water and the alkaline solution of the complexing agent from mixing with one another. For this purpose, for example, the well can be purged with a purge fluid in a preceding step and/or the well can be shut off, in order that no further deposit water can penetrate into the well. This can be done, for example, mechanically by means of an insert, which closes the perforations of the well lining. Such measures by their nature mean additional cost and inconvenience.

WO 2006/092438 A1 discloses the use of water-soluble alkanesulfonic acids to increase the permeability of underground, carbonatic mineral oil- or natural gas-bearing rock formations, and for dissolution of carbonatic and/or carbonate-containing impurities in mineral oil production. The dissolution of sulfate-containing deposits is not described.

Prior application U.S. 61/475531 discloses a process for dissolving deposits from surfaces with an aqueous formulation comprising 3 to 15% by weight of at least one complexing agent selected from the group of MGDA, NTA, HEDTA, GLDA, EDTA and DTPA, and 3 to 15% by weight of at least one acid. The acid may, for example, be methanesulfonic acid. The pH of the formulation is 3 to 9. The deposits may, for example, be CaCO₃ or CaSO₄. The surfaces which are to be freed of deposits may, for example, be the surfaces of turbines, ships' hulls, solar collectors, osmotic membranes, heating elements, reactors, mineral oil deposits, water wells, geothermal wells or mineral oil wells.

### SUMMARY

Principles and embodiments of the invention relate to providing an improved process for eliminating deposits of alkaline earth metal sulfates in underground installations or installation parts for production of mineral oil, natural gas or water, which does not have the disadvantage of causing secondary deposits.

One or more embodiments of the invention relate to a process for dissolving deposits comprising alkaline earth metal sulfates in underground installations or installation parts for production of mineral oil and/or natural gas and/or water from underground formations, by injecting an aqueous formulation for dissolution of the deposits into the underground installations and allowing it to act on the deposits, wherein the aqueous formulation comprises at least

(I) 15% by weight to 98.98% by weight of water,

(II) 1% by weight to 75% by weight of methanesulfonic acid,

(III) 0.01% by weight to 5% by weight of at least water-miscible organic solvent, and

(IV) 0.01% by weight to 5% by weight of at least one corrosion inhibitor,

and where the pH of the formulation used is 2.5 and the sum of components (I), (II), (III) and (IV) is at least 80% by weight based on the sum of all constituents.

In an embodiment of the process, the underground installations are a well or the reservoir rock.

In an embodiments, the deposits comprise calcium sulfate, strontium sulfate and/or barium sulfate.

In an embodiment, the deposits are deposits comprising strontium sulfate and/or barium sulfate.

In an embodiment of the process, the underground formation comprises formation water with ions dissolved therein, selected from the group of Mg²⁺, Ca²⁺, Sr²⁺ and Ba²⁺, and the installations or installation parts are in contact with the formation water during the execution of the process.

In an embodiment, the well is not shut off from the formation during the execution of the process.

In an embodiment, a flow of formation water into the well is prevented by applying a pressure equal to or greater than the pressure of the formation water.

In various embodiments, for execution of the process, an aqueous formulation comprising at least components (I), (II), (III) and (IV) is used. As well as components (I) to (IV), the formulation used may optionally comprise further components.

As component (I), the formulation for one or more embodiments comprises water.

As component (II), the formulation for one or more embodiments comprises methanesulfonic acid. Methanesulfonic acid is commercially available, for example in pure form or as an about 70% by weight aqueous solution.

As component (III) for one or more embodiments comprises the at least one water-miscible organic solvent. The deposits to be dissolved in the installations or installation parts are typically oil-wetted, which hinders rapid dissolution of deposits. Organic solvents therefore enable faster removal by dissolution. The solvents used may be entirely or else only partly miscible with water. The minimum condition is that no phase separation of water and organic solvent occurs at the concentration used and under the use conditions.

Examples of suitable organic solvents for one or more embodiments comprise alcohols such as ethanol, n-propanol, i-propanol, n-butanol, i-butanol, glycols such as ethylene glycol, diethylene glycol, propylene glycol or glycol ethers, for example ethylene glycol monobutyl ether. It will be appreciated that it is also possible to use mixtures of two or more different water-miscible organic solvents.

In one or more embodiments of the process, the aqueous formulation comprises at least

(I) 44% by weight to 94.8% by weight of water,

(II) 5% by weight to 50% by weight of methanesulfonic acid,

(III) 0.1% by weight to 3% by weight of at least one water-miscible organic solvent, and

(IV) 0.01% by weight to 3% by weight of at least one corrosion inhibitor.

In one or more embodiments of the process, the aqueous formulation comprises at least

(I) 66% by weight to 83.6% by weight of water,

(II) 16% by weight to 30% by weight of methanesulfonic acid,

(III) 0.2% by weight to 2% by weight of at least one water-miscible organic solvent, and

(IV) 0.2% by weight to 2% by weight of at least one corrosion inhibitor.

### BRIEF DESCRIPTION OF DRAWINGS

FIG. 1 illustrates results of experiments at room temperature;

FIG. 2 illustrates results of experiments at 60° C.; and

FIG. 3 illustrates results of experiments at 90° C.

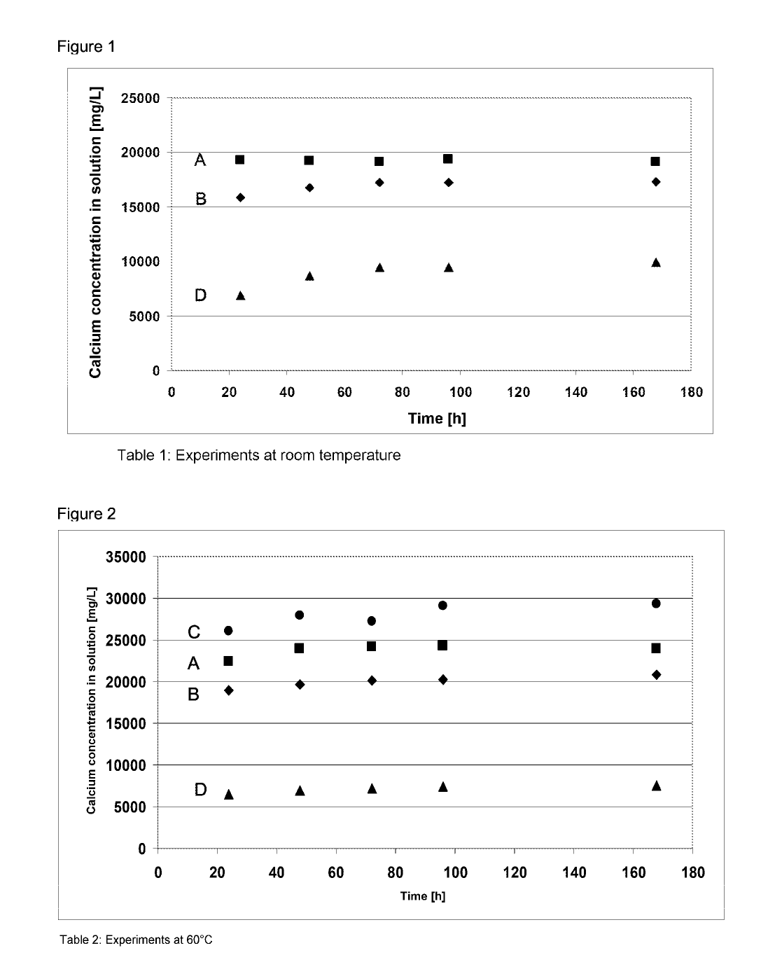

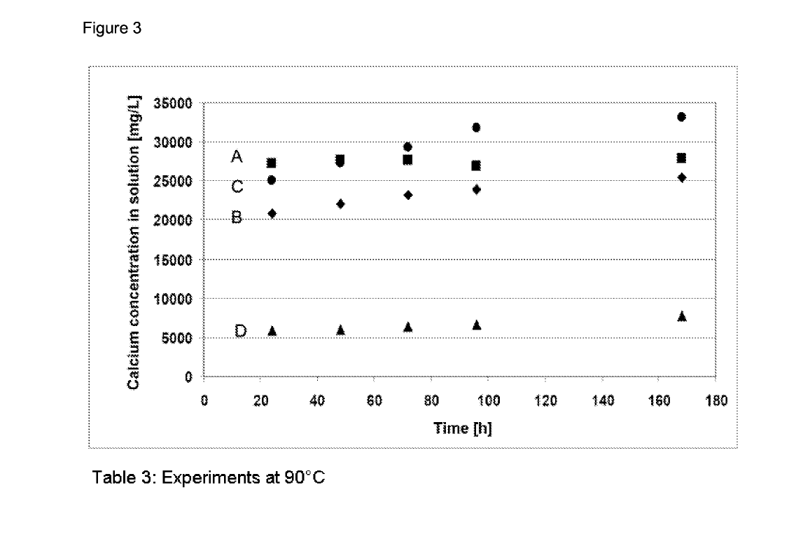

### DETAILED DESCRIPTION

As component (IV), the formulation for one or more embodiments comprises at least one corrosion inhibitor. Examples of suitable corrosion inhibitors comprise polyether phosphates, butynediol, butynediol alkoxylates or alkyl phosphates. It will be appreciated that it is also possible to use mixtures of two or more different corrosion inhibitors.

According to one or more embodiments of the invention, the pH of the formulation used is ≦2.5, or ≦2, or ≦1. The pH can be adjusted easily by the person skilled in the art in a manner known in principle through the concentration of the methanesulfonic acid.

Examples of further components optionally present in the formulations comprise further acids as well as methanesulfonic acid, for example hydrochloric acid, hydrofluoric acid, formic acid or acetic acid, or surfactants. In special cases, complexing agents may be present as further components in small amounts, but may be absent.

According to various embodiments of the invention, the formulation comprises components (I) to (IV) in the following amounts (all figures in % by weight):

| | |
|---|---|
| (I) water | 15-98.98 |
| (II) methanesulfonic acid | 1-75 |
| (III) organic solvents | 0.01-5 |
| (IV) corrosion inhibitors | 0.01-5 |

It is possible to use the following amounts (all figures in % by weight):

| | | more | most |
|---|---|---|---|
| | particularly | particularly | particularly |
| (I) water | 44-94.8 | 56-89.6 | 66-83.6 |
| (II) methanesulfonic acid | 5-50 | 10-40 | 16-30 |
| (III) organic solvents | 0.1-3 | 0.2-2 | 0.2-2 |
| (IV) corrosion inhibitors | 0.1-3 | 0.2-2 | 0.2-2 |

According to various embodiments of the invention, the sum of components (I), (II), (III) and (IV) is at least 80% by weight based on the sum of all constituents, or at least 90% by weight, or at least 95% by weight, or 100% by weight, i.e. no further components are present in the formulation apart from components (I) to (IV). If further components are present at all, the amount thereof should still generally not exceed 50% by weight, or 25% by weight, or 10% by weight of the amount of components (II), (III) and (IV).

In the process according to various embodiments of the invention, the formulation for dissolving deposits comprising alkaline earth metal sulfates is used in underground installations or installation parts for production of mineral oil and/or natural gas and/or water from underground formations.

The underground formations may be underground mineral oil and/or natural gas deposits, the mineral oil or natural gas deposits comprising not only mineral oil and/or natural gas but also formation water with a greater or lesser salt content. The deposit water may be of natural origin, or else it may be water which has been injected into the formation. It is possible to use fresh water or else salt water for injection into formations. For example, salt water may be sea water or else produced deposit water which is injected again.

The formation water may trade especially alkali metal ions and alkaline earth metal ions, and, as anions, halide ions, especially chloride ions, and also other ions such as sulfate ions. More particularly, the formation water comprises dissolved alkaline earth metal ions, especially those selected from the group of Mg²⁺, Ca²⁺, Sr²⁺ and Ba²⁺, and additionally dissolved SO₄²⁻.

In addition, the formations may also be those from which exclusively water is produced. The water may be natural water in the formation, or water which has been injected into the formation, for example for geothermal power generation.

The underground installations or installation parts are those installation parts arranged underground which connect the underground formation hydraulically to the surface of the earth, i.e. installations or installation parts which ensure a flow path for mineral oil, natural gas and water from the formation to the surface of the earth. More particularly, these are wells, including customary installations in wells, for example the well wall composed of steel pipes, production strings, tailpipes and fittings thereof, or pump elements, for example rotors, stators or pump column. The underground installation or installation parts may also be reservoir rock, more particularly the reservoir rock surrounding the well. Particular attention may be given to wells, particularly wells lined with steel pipes.

The deposits may be all kinds of deposits comprising alkaline earth metal sulfates. Examples comprise CaSO₄, CaSO₄*½ H₂O, CaSO₄*2 H₂O, SrSO₄ or BaSO₄.

As well as the alkaline earth metal sulfates, the deposits may also comprise other components. Mention should be made here firstly of carbonatic deposits, such as CaCO₃ and/or MgCO₃-deposits. Secondly, the deposits may be contaminated with oils and/or oil constituents, such as paraffins, asphaltenes or naphthenates, or with residues of corrosion inhibitors.

The deposits may be present on the inner walls of the installations or installation parts, for example on the inner wall of wells. They may, however, for example, also have fully or partly blocked holes, for example the perforation of the well at the hydraulic connection to the formation. Deposits may also be present within the formation in the region close to the well. Such deposits prevent the transport of the hydrocarbons to the well.

The process according to one or more embodiments of the invention is executed by injecting the above-described formulation into the underground installations or installation parts, more particularly into the well and optionally into the reservoir rock, and allowing it to act on the deposits. This can be accomplished by means of customary pumps, and the pressure is selected by the person skilled in the art according to the conditions. By means of the pressure, the person skilled in the art can influence the extent to which the formulation can penetrate into the installations or installation parts, or optionally through the perforation into the formation.

The deposits comprising alkaline earth metal sulfates dissolve under the influence of the aqueous formulation containing methanesulfonic acid. The contact time is determined by the person skilled in the art according to the desired result. It may be 1 h to 300 h, or 2 h to 200 h, without any intention that the invention be restricted to this duration. It is conceivable to preheat the formulation to a particular temperature. Typically, the formulation in the installations or installation parts heats with time to the prevailing temperature in these installations or installation parts, though the temperature typically will not be homogeneous, but instead variable, for example, according to the depth of the well.

In an embodiment of the invention, the underground formation comprises formation water with ions dissolved therein, selected from the group of Mg²⁺, Ca²⁺, Sr²⁺ and Ba²⁺, the installations or installation parts being in contact with the formation water during the execution of the process.

In one embodiment of the invention, the installation or installation part, for example a well, may still comprise residues of the formation water comprising ions selected from the group of Mg²⁺, Ca²⁺, Sr²⁺ and Ba²⁺. It is the particular advantage of embodiments of this invention that no preceding purging of the installation or installation parts prior to the contacting with the formulation to be used in accordance with various embodiments of the invention is required, because the acidic methanesulfonic acid formulation does not lead to any precipitation with the ions mentioned.

In addition, the installation or installation part may still stand hydraulically with the formation during the execution of the process, such that formation water can still flow into the installation or installation part and mix with the acidic formulation. It is not necessary for the installation or installation part to be completely shut off hydraulically from the formation.

In an embodiment of the invention, in the course of treatment of a well, the well is not shut off from the formation, but instead the connection to the formation remains open, for example through a perforation in the well wall. In this embodiment, it is advantageously possible to at least partly prevent the flow of formation water comprising ions selected from the group of Mg²⁺, Ca²⁺, Sr²⁺ and Ba²⁺ into the well by applying a pressure equal to or greater than the pressure of the formation water. At approximately equal pressure, there will nevertheless be a certain degree of mixing of acidic formulation and formation water at the contact site. In the case of pressure, the acidic formulation can flow into the formation, where there may likewise be mixing with formation water. However, in contrast to alkaline formulations comprising complexing agents, this does not result in secondary precipitation which could block the formation.

The examples which follow are intended to illustrate exemplary embodiments of the invention in detail:

The experiments studied the capacity of hydrochloric acid, methanesulfonic acid and of a commercial detergent comprising complexing agents for sulfate deposits.

Materials used:
(A) Hydrochloric acid, 10% by weight solution in water
(B) Methanesulfonic acid, 20% by weight solution in water
(C) Commercial deposit dissolver (SRW 85247 Baker Petrolite), comprises 30 to 60% by weight of the complexing agent disodium ethanoldiglycinate and 1 to 5% by weight of NaOH in aqueous solution, diluted with water to 20% by weight of detergent, pH 10
(D) Commercial deposit dissolver as (C), diluted to 20% by weight with water and HCl, pH 5

Calcium sulfate powder (Afla Aesar)

General experimental method:

2 g of the calcium sulfate powder in each case were stored with 40 ml in each case of dissolver (A), (B), (C) or (D) in a Teflon-lined closed steel vessel at various temperatures for various times of up to 168 h (i.e. 1 week). After the end of the experiment and cooling to room temperature, the calcium content in the solution was analyzed in each case. For this purpose, EDTA was added to the mixture in the steel vessel in order to hinder the precipitation of dissolved Ca²⁺, and the mixture was filtered through a very fine filter (0.2 μm filter). The filtrate was used for analysis. Tests were conducted at room temperature, 60° C. and 90° C.

The results are compiled in tables 1, 2 and 3.

The results show that the dissolver (C), which comprises complexing agent and NaOH (pH 10), has a good dissolution capacity for calcium. If such a dissolver, however, is acidified to pH 5 in order to avoid the problem of secondary precipitation (experiment (D)), this dissolver exhibits only very low efficacy.

Hydrochloric acid and methanesulfonic acid have similar efficacy, but methanesulfonic acid is known to be much less corrosive than methanesulfonic acid.

What is claimed is:

1. A process for dissolving deposits comprising alkaline earth metal sulfates in underground installations or installation parts for production of mineral oil and/or natural gas and/or water from underground formations, which comprises:
injecting an aqueous formulation for dissolution of the deposits into the underground installations, and
allowing it to act on the deposits, wherein the aqueous formulation comprises:
(I) 15% by weight to 98.98% by weight of water,
(II) 1% by weight to 75% by weight of methanesulfonic acid,
(III) 0.01% by weight to 5% by weight of at least one water-miscible organic solvent, and
(IV) 0.01% by weight to 5% by weight of at least one corrosion inhibitor,
where the pH of the formulation used is ≦2.5 and the sum of components (I), (II), (III) and (IV) is at least 80% by weight based on the sum of all constituents.

2. The process according to claim 1, wherein the deposits comprise calcium sulfate, strontium sulfate and/or barium sulfate.

3. The process according to claim 1, wherein the deposits are deposits comprising strontium sulfate and/or barium sulfate.

4. The process according to claim 1, wherein the underground formation comprises formation water with ions dissolved therein, selected from the group of Mg²⁺, Ca²⁺, Sr²⁺ and Ba²⁺, and the installations or installation parts are in contact with the formation water during the execution of the process.

5. The process according to claim 1, wherein the installation is a well and/or the adjoining reservoir rock.

6. The process according to claim 5, wherein the well is not shut off from the formation during the execution of the process.

7. The process according to claim 6, wherein a flow of formation water into the well is prevented by applying a pressure equal to or greater than the pressure of the formation water.

8. The process according to claim 1, wherein the aqueous formulation comprises
(I) 44% by weight to 94.8% by weight of water,
(II) 5% by weight to 50% by weight of methanesulfonic acid,
(III) 0.1% by weight to 3% by weight of at least one water-miscible organic solvent, and
(IV) 0.01% by weight to 3% by weight of at least one corrosion inhibitor.

9. The process according to claim 1, wherein the aqueous formulation comprises
(I) 166% by weight to 83.6% by weight of water,
(II) 16% by weight to 30% by weight of methanesulfonic acid,
(III) 0.2% by weight to 2% by weight of at least one water-miscible organic solvent, and
(IV) 0.2% by weight to 2% by weight of at least one corrosion inhibitor.

10. The process according to claim 1, wherein the water-miscible organic solvent is at least one selected from the group of ethanol, n-propanol, i-propanol, n-butanol, i-butanol, glycols and glycol ethers.
